(19) United States
(12) Patent Application Publication
(10) Pub. No.: US 2012/0308877 A1
(43) Pub. Date: Dec. 6, 2012

(54) ELECTRICAL APPLIANCE

(75) Inventor: Tsuyoshi Hirai, Tokyo (JP)

(73) Assignee: MITSUBISHI HEAVY INDUSTRIES, LTD., Tokyo (JP)

(21) Appl. No.: 13/482,576

(22) Filed: May 29, 2012

(30) Foreign Application Priority Data
May 31, 2011 (JP) 2011-121147

(51) Int. Cl. H01M 2/30; H01M 2/08

(52) U.S. Cl. 429/184

(57) ABSTRACT

An electrical appliance includes a support member having a step portion and having an inner region portion in which a through-hole is formed, an electrode terminal arranged to pass through the through-hole so as not to contact the support member, and of which at least one end is protruded from the support member, and an insulating resin formed integrally and contacted to an adhesion place of the electrode terminal, the inner region portion and the step portion so as to seal the through-hole.

### TECHNICAL FIELD

The present invention relates to an electrical appliance in which an electrode terminal is fixed by an insulating resin.

### BACKGROUND ART

An electrical appliance in which electrode terminals are fixed by an insulating resin may be exemplified as, for example, a battery. The battery may be classified as a primary battery, which is dischargeable, or a secondary battery, which is chargeable and dischargeable. These batteries typically have a configuration in which a battery container hermetically seals a stacked electrode body together with an electrolyte. The stacked electrode is formed by stacking electrode plates, that is, a positive electrode plate and a negative electrode plate with a separator interposed between them.

The battery container is generally constituted by a battery container main body configured to accommodate the electrode plates, and a battery cover having a flat plate shape and configured to cover an opening of the battery container main body. The battery cover, which functions as a support member configured to support the electrode terminals, has through-holes to expose the electrode terminals electrically connected to the electrode plates.

Here, in order to enclose the inside and the outside of the battery container, for example, the battery container is configured by filling gaps of the through-holes, through which the electrode terminals pass, with an insulating resin, integrally adhering the electrode terminal and the battery cover, and welding an outer circumference of the battery cover and a circumference of the opening of the battery container main body (See Patent Document 1).

### RELATED ART DOCUMENT

### Patent Document

[Patent Document 1] Japanese Patent Application Laid-Open No.: 2011-76731

### SUMMARY OF THE INVENTION

### Problems to be Solved by the Invention

However, in the battery disclosed in Patent Document 1, in a place in which the electrode terminals and the battery cover are adhered by the insulating resin, since the insulating resin is formed to contact a plane of the battery cover, a close contact area between the battery cover and the insulating resin is small. For this reason, for example, moisture, and so on, present in the atmosphere outside the battery container may enter the inside of the battery container through a path generated between the battery cover and the insulating resin, which may cause insufficient tightness of sealing. In order to prevent moisture present outside the battery container from entering the inside, the close contact area between the battery cover and the insulating resin, in other words, a path (distance) between the battery cover and insulating resin from the outside to the inside of the battery container, through which moisture passes, may be increased.

Here, in order to increase the close contact area between the battery cover and the insulating resin, a method of further increasing a region at which the insulating resin is formed on the same plane of the battery cover is considered. However, for example, when a surface shape of the battery cover is rectangular, the width of the battery cover in a direction perpendicular to a longitudinal direction thereof may be reduced, and a region at which the insulating resin is formed may not be sufficiently secured. In addition, even when a safety valve is installed at the battery cover, if the distance between the electrode terminals and the safety valve is short, the region at which the insulating resin is formed cannot be sufficiently secured.

Accordingly, in consideration of the above-mentioned problems, it is an object of the present invention to provide an electrical appliance having a novel structure in which sealing performance is improved. The electrical appliance may be a battery, and so on, in which the electrode terminals are fixed by the insulating resin, and sealing or waterproofing performance is required.

### Means for Solving the Problems

An electrical appliance in accordance with the present invention includes a support member having a step portion and having an inner region portion in which a through-hole is formed, an electrode terminal arranged to pass through the through-hole so as not to contact the support member, and of which at least one end is protruded from the support member, and an insulating resin formed integrally and contacted to an adhesion place of the electrode terminal, the inner region portion and the step portion so as to seal the through-hole.

In addition, an electrical appliance in accordance with the present invention comprises a container main body which stores an electrode plate, and a support member, which covers an opening of the container main body, having a through-hole to expose an electrode terminal electrically connected to the electrode plate, from an inner region portion connected to a step portion on a surface of the support member, wherein the support member is integrated with the electrode terminal passing through the through-hole, for an insulating resin to adhere an adhesion place of the electrode terminal, the inner region portion, and the step portion.

According to the related configuration, the insulating resin is also formed to be in contact with the step portion in addition to the inner region portion. Therefore, the close contact area between the support member and the insulating resin can be increased to improve sealing performance. As a result, moisture, and so on, present outside the electrical appliance can be suppressed from entering the inside of the electrical appliance.

### Effect of the Invention

As described above, according to the above-mentioned electrical appliance of the present invention, sealing or waterproofing performance can be improved.

### BRIEF DESCRIPTION OF THE DRAWINGS

FIG. 1 is a schematic perspective view of a battery of the first embodiment of the present invention.

FIG. 2 shows a schematic view of a battery cover of the first embodiment of the present invention, FIG. 2(a) showing a plan view of the battery cover, and FIG. 2(b) showing a cross-sectional view taken along line A-A′ of FIG. 2(a).

FIG. 3 is a view for explaining availability of sealing performance of the battery cover of the first embodiment of the present invention, FIG. 3(a) showing a cross-sectional view of a conventional battery cover, and FIG. 3(b) showing a cross-sectional view of the battery cover of the first embodiment.

FIG. 4 is a schematic view of a battery cover of a second embodiment of the present invention, FIG. 4(a) showing a plan view of the battery cover, and FIG. 4(b) showing a cross-sectional view taken along line B-B′ of FIG. 4(a).

FIG. 5 shows schematic views of variants 1 and 2 of the battery cover of the first embodiment of the present invention, FIG. 5(a) showing a cross-sectional view of the battery cover of the variant 1, and FIG. 5(b) showing a cross-sectional view of the battery cover of the variant 2.

FIG. 6 is a schematic view of the variant 2 of the battery cover of the first embodiment of the present invention, FIG. 6(a) showing a plan view of the battery cover, and FIG. 6(b) showing a cross-sectional view taken along line D-D′ of FIG. 6(a).

FIG. 7 is a schematic view of a variant of the battery cover of the second embodiment of the present invention, showing a cross-sectional view of a portion of the battery cover.

### BEST MODE FOR CARRYING OUT THE INVENTION

Hereinafter, exemplary embodiments in accordance with the present invention will be described with reference to the accompanying drawings. In addition, the present invention can be applied to any products or apparatus under a condition that an electrical appliance has electrode terminals fixed by an insulating resin. For example, the present invention can be applied to a mobile phone, a washing machine, and further to a vehicle, which require sealing or waterproofing performance. However, in the following embodiments, as an example of the electrical appliance, a battery, in particular, a lithium secondary battery, is exemplarily described.

### First Embodiment

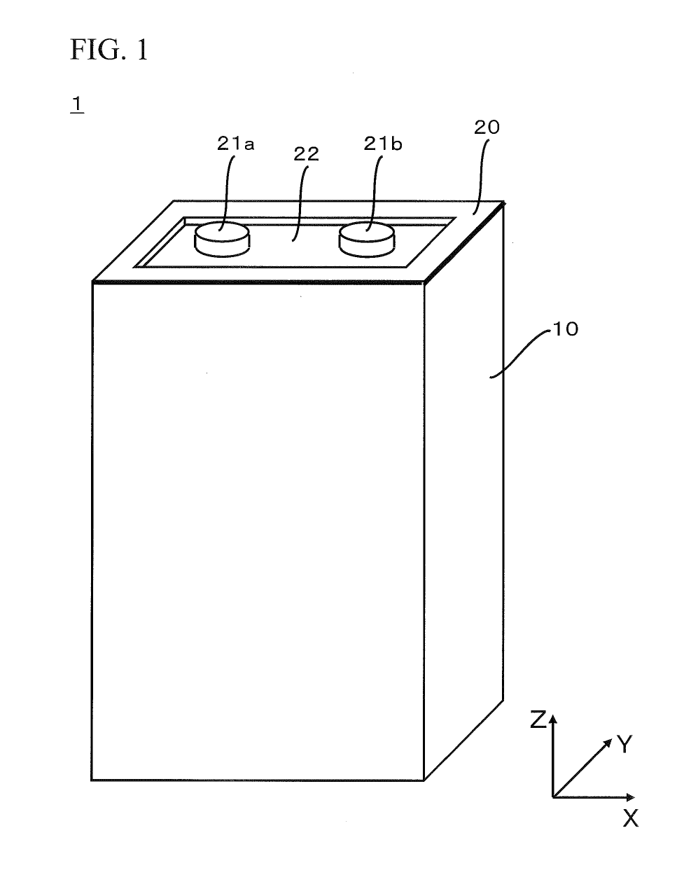

FIG. 1 is a schematic perspective view of a battery of a first embodiment of the present invention.

A battery 1 of the first embodiment of the present invention, as shown in FIG. 1, is constituted by a battery container main body 10, and a battery cover 20. The battery cover 20 covers an opening of the battery container main body 10.

The battery container main body 10 is a container configured to store a stacked electrode body (not shown) in which electrode plates, that is, a positive electrode plate and a negative electrode plate, are stacked with a separator interposed between them, together with electrolyte. The battery container main body 10 is formed of a metal material such as an aluminum alloy. A positive electrode tab is formed at one end of the positive electrode plate, and the positive electrode tab and a positive electrode terminal (electrode terminal) 21a are electrically connected to a positive electrode lead. In addition, a negative electrode tab is formed at one end of the negative electrode plate, and the negative electrode tab and a negative electrode terminal (electrode terminal) 21b are electrically connected to a negative electrode lead. Accordingly, current can be applied from the positive electrode terminal 21a and the negative electrode terminal 21b.

The battery cover 20 is a cover having a flat plate shape and configured to cover and seal the battery container main body 10, and similar to the battery container main body, is formed of a metal material such as an aluminum alloy. The battery cover 20 includes the positive electrode terminal 21a, the negative electrode terminal 21b, and the insulating resin (for example, a resin such as a thermosetting resin or a thermoplastic resin) 22. The positive electrode terminal 21a and the negative electrode terminal 21b are arranged via through-holes (not shown in FIG. 1) formed in the battery cover 20. The insulating resin 22 integrally attaches the battery cover 20 to the positive electrode terminal 21a and the negative electrode terminal 21b and electrically insulates them from each other. The positive electrode terminal 21a and the negative electrode terminal 21b pass through the battery cover 20, that is, in a state in which the electrode terminals pass through the through-holes of the battery cover 20 not to contact the battery cover 20 and in a state in which at least one end (both ends in the embodiment) of the electrode terminal protrudes from the battery cover 20, the insulating resin (sealing member) 22 is filled in the through-holes. Accordingly, the battery cover 20 is integrally adhered to the positive electrode terminal 21a and the negative electrode terminal 21b to seal gaps of the through-holes. In addition, after accommodation of the stacked electrode body, and so on, in the battery container main body 10, as an outer circumference of the battery cover 20 is welded (for example, by laser welding) to a circumference of an opening of the battery container main body 10, the battery container main body 10 is enclosed. That is, the battery cover 20 is a “support member” configured to support the electrode terminal arranged at a predetermined position via the insulating resin. Further, hereinafter, the embodiment will be described with reference to an XYZ Cartesian coordinate system. In the battery 1, a vertical direction from a bottom surface (a surface opposite to the battery cover 20) of the battery container main body 10 shown in FIG. 1 to the battery cover 20 is a +Z direction of a Z-axis direction (the Z-axis direction has a +Z direction and a −Z direction), a direction perpendicular to the Z-axis direction and along a side in a longitudinal direction of the battery cover 20 is an X-axis direction, and a direction perpendicular to the X-axis direction and the Z-axis direction (a direction along a side of the battery cover 20 perpendicular to the longitudinal direction) is a Y-axis direction.

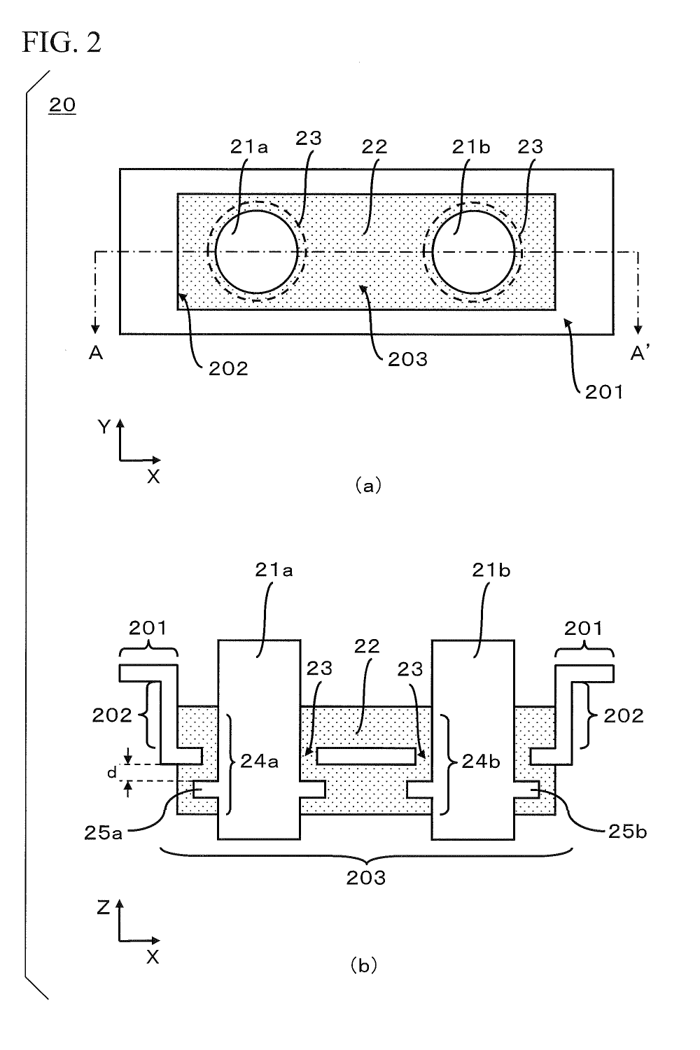

Here, shapes of the battery cover 20 and the electrode terminals (the positive electrode terminal 21a and the negative electrode terminal 21b) of the first embodiment of the present invention and an adhesion structure of the battery cover 20 and the electrode terminals (the positive electrode terminal 21a and the negative electrode terminal 21b) by the insulating resin 22 will be described in detail with reference to FIG. 2. FIG. 2(a) shows a plan view of the battery cover, and FIG. 2(b) is a cross-sectional view taken along line A-A′ of FIG. 2(a).

As shown in FIG. 2(a) and FIG. 2(b), the battery cover 20 has regions such as a first region portion (outer region portion) 201, a second region portion (step portion) 202, and a third region portion (inner region portion) 203 on a surface of the battery cover 20. The outer region portion 201 is a region positioned at an outer side on a surface of the battery cover 20 including the outer circumference of the battery cover 20 welded to the circumference of the opening of the battery container main body 10. The inner region portion 203 is a region positioned at an inner side on a surface of the battery cover 20 in which the through-holes 23 are arranged, and the inner region portion 203 is positioned in the −Z direction (a bottom surface side of the battery container main body 101) via a step portion 202, from the outer region portion 201. The step portion 202 is a region positioned between the outer region portion 201 and the inner region portion 203 and configured to connect the outer region portion 201 and the inner region portion 203 in a stepped shape. As shown in FIG. 2(b), a cross-sectional shape of the battery cover 20 may be configured such that a cross-section of the outer region portion 201 and the inner region portion 203 and a cross-section of the step portion 202 have an angle of 90 degrees. However, the cross-sectional shape of the battery cover 20 is not limited to this case but, for example, may be configured such that the cross-section of the outer region portion 201 and the inner region portion 203 and the cross-section of the step portion 202 have a predetermined angle (for example, 45 degrees). In addition, while the step portion 202 may have a stepped shape having one stage formed from the outer region portion 201 to the inner region portion 203, the stepped shape is not limited thereto but may have at least two stages.

The positive electrode terminal 21a and the negative electrode terminal 21b have places (hereinafter referred to as “adhesion places”) 24a and 24b that are adhered to the insulating resin 22. A convex portion 25a is formed at a portion of the adhesion place 24a of the positive electrode terminal 21a over the entire circumference in a direction perpendicular or substantially perpendicular to the direction passing through the through-holes 23. In addition, a convex portion 25b is formed at a portion of the adhesion place 24b of the negative electrode terminal 21b over the entire circumference in a direction perpendicular or substantially perpendicular to the direction passing through the through-holes 23. Each of the convex portions 25a and 25b of the positive electrode terminal 21a and the negative electrode terminal 21b is formed at a position having a predetermined distance d in a −Z direction (a bottom surface side when seen from a surface of the battery cover 20 of the battery container main body 10), rather than a surface of the inner region portion 203 on which the through-holes 23 of the battery cover 20 are formed. Here, the predetermined distance d is a distance in the Z-axis direction because an amount of insulating resin for maintaining insulation from and adhesion to the convex portion 25a of the positive electrode terminal 21a to the battery cover 20 (and the convex portion 25b of the negative electrode terminal 21b to the battery cover 20) can be filled. In addition, the predetermined distance d is a distance in the Z-axis direction between the battery cover 20 and the convex portion 25a of the positive electrode terminal 21a (and between the battery cover 20 and the convex portion 25b of the negative electrode terminal 21b), and d>0.

As each of the convex portions 25a and 25b is formed as described above, each of the convex portions 25a and 25b can avoid contact (or risk of contact) with the inner region portion 203 of the battery cover 20. As a result, without enlarging the gap (a width in an XY plane direction) for installing the insulating resin 22 between the battery cover 20 and the positive electrode terminal 21a, the convex portion 25a is formed. In addition, without enlarging the gap (a width in an XY plane direction) for installing the insulating resin 22 between the battery cover 20 and the negative electrode terminal 21b, the convex portion 25b can be formed. Further, the convex portions 25a and 25b are not limited to the case in which they are formed at positions having a predetermined distance d in the −Z direction (a bottom surface side when seen from a surface of the battery cover 20 of the battery container main body 10) from the surface having the through-holes 23, respectively. For example, each of the convex portions 25a and 25b may be arranged at a position having a predetermined distance d in the +Z direction (an outer side of the battery container main body 10) from the surface in which the through-holes 23 are formed. In addition, the convex portions 25a and 25b may be arranged at predetermined distances d in both of the ±Z directions from the surface in which the through-holes 23 are formed, respectively. Further, the shape of each of the convex portions 25a and 25b is not limited to the shape shown in the drawing but may be appropriately varied, for example, the convex portion may have a convex shape with at least two stages. Furthermore, under the condition that there is no risk of contact of the battery cover 20 with the positive electrode terminal 21a (or the negative electrode terminal 21b), insulation of the battery cover 20 from the positive electrode terminal 21a (and the negative electrode terminal 21b) is maintained by the insulating resin 22 and contact strength is sufficiently provided, each of the convex portions 25a and 25b may be arranged on the same plane (XY plane) as the surface in which the through-holes 23 are formed.

In the battery cover 20 including the regions, the positive electrode terminal 21a and the negative electrode terminal 21b passing through the through-holes 23 arranged in the inner region portion 203 and exposed thereto are adhered to be integrated with the battery cover 20 by the insulating resin 22. At this time, the insulating resin 22 is formed on the adhesion places 24a and 24b of the positive electrode terminal 21a and the negative electrode terminal 21b, and the inner region portion 203 and at least portions of the step portion 202. More specifically, in a front surface side of the battery cover 20 (an opposite side of the battery container main body side), the insulating resin 22 is formed to fill between the surface of the step portion 202, the surface of the inner region portion 203, and the adhesion places 24a and 24b of the positive electrode terminal 21a and the negative electrode terminal 21b. Further, in a rear surface side of the battery cover 20 (the battery container main body side), the insulating resin 22 is formed between the surface of the inner region portion 203, and the adhesion places 24a and 24b (including the convex portions 25a and 25b) of the positive electrode terminal 21a and the negative electrode terminal 21b.

According to the battery 1 of the first embodiment of the present invention as configured above, the insulating resin 22 is also formed to contact the step portion 202 in addition to the inner region portion 203, and further, the insulating resin 22 is also formed to contact the convex portions of the positive electrode terminal 21a and the negative electrode terminal 21b. Thus, the close contact area between the battery cover 20 and the insulating resin 22 can be increased to improve sealing performance. As a result, it is possible to suppress a moisture and so on, present outside the battery container from entering inside of the battery container, and simultaneously, to suppress an electrolyte and so on, present in the battery container, from leaking to the outside of the battery container.

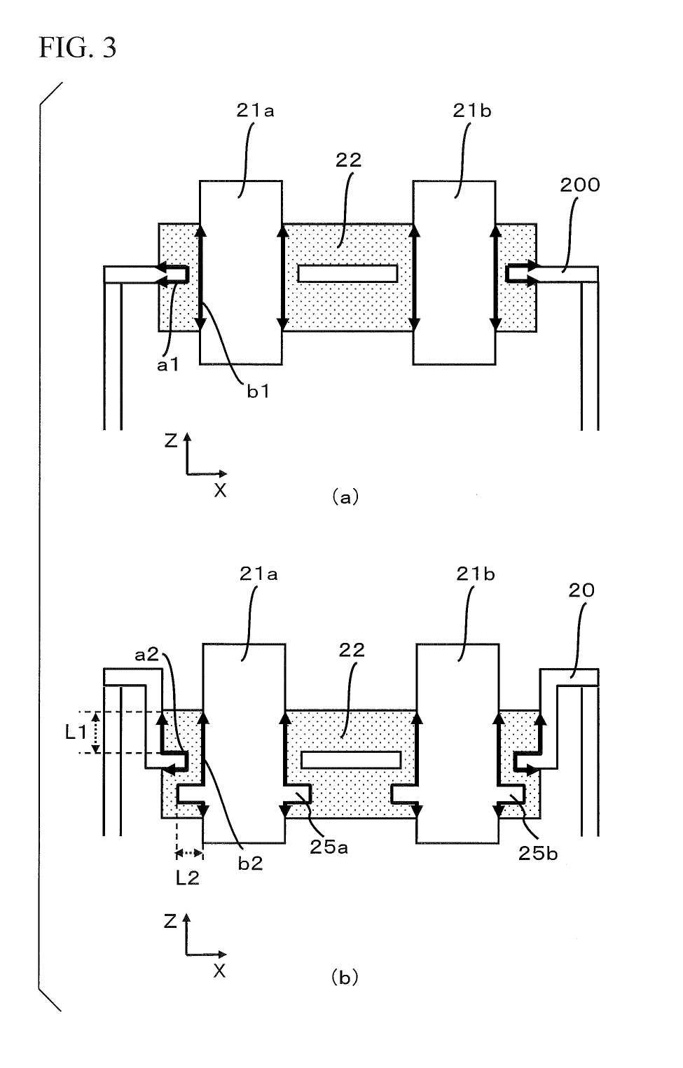

The above will be specifically described with reference to FIG. 3. That is, in a conventional battery shown in FIG. 3(a), moisture, and so on, present outside the battery container may enter the inside of the battery container from the outside thereof through a path a1 between the battery cover 200 and the insulating resin 22, and a path b1 between the positive electrode terminal 21a and the negative electrode terminal 21b and the insulating resin 22. The path a1 is a shortest path from the front surface (a plane disposed at the +Z direction side) of the battery cover 200, on which the insulating resin 22 is formed to contact therewith, to the rear surface (a plane disposed at the −Z direction side) of the battery cover 200 via the through-holes 23. In addition, the path b1 is a shortest path from the outer side of the battery 1 of the positive electrode terminal 21a and the negative electrode terminal 21b, on which the insulating resin 22 is formed to contact therewith, to the inner side thereof.

Meanwhile, in the battery 1 of the first embodiment of the present invention shown in FIG. 3(b), moisture, and so on, present outside the battery container enters the inside of the battery container from the outside thereof through a path a2 between the battery cover 20 and the insulating resin 22, and a path b2 between the positive electrode terminal 21a and the negative electrode terminal 21b and the insulating resin 22. A distance of the path a2 between the battery cover 20 and the insulating resin 22 is increased by a distance L1 in which the insulating resin 22 is formed to contact the step portion 202, in addition to the distance of path a1. In addition, a distance of the path b2 between the positive electrode terminal 21a and the negative electrode terminal 21b and the insulating resin 22 is increased by a distance (L2×2) in which the insulating resin 22 is increased by forming the convex portions 25a and 25b, in addition to the distance of the path b1.

Accordingly, since the paths a2 and b2 have distances larger than those of the paths a1 and b1 of the conventional battery, respectively, the risk of entrance of moisture, and so on, into the inside can be suppressed. In particular, according to the battery 1 of the embodiment, in comparison with the conventional battery, with no substantial increase in the amount of the insulating resin 22, adherence can be increased. In addition, since the battery 1 of the first embodiment of the present invention has a structure in which the close contact area with the insulating resin 22 is increased by installing the step portion 202, due to restriction of the width of the battery cover 20, the present invention is especially useful when the region on which the insulating resin 22 is formed cannot be further increased on the same plane of the battery cover 20.

Further, according to a structure of the battery cover 20 of the first embodiment of the present invention, sealing performance of a spot at which the battery cover 20 is welded to the battery container main body 10 can be improved. That is, before the battery cover 20 is welded to the battery container main body 10, while immersion of the battery cover 20 in a silane coupling agent is needed to improve the adhesive property of the insulating resin 22, since the conventional battery cover 20 has a flat plate shape with no convex or concave shape, the entire battery cover 20 is immersed in the silane coupling agent. In this case, the silane coupling agent is attached to places other than the adhesion places of the positive electrode terminal 21a and the negative electrode terminal 21b, for example, the outer circumference of the battery cover 20, which is a welding place to the circumference of the battery container main body 10, and the silane coupling agent causes degradation of a welding property between the battery cover 20 and the battery container main body 10. However, since the battery cover 20 of the first embodiment of the present invention has the step portion 202 and the battery cover 20 is a flat plate with concave and convex portions, only the step portion 202 and the inner region portion 203 can be immersed in the silane coupling agent. Accordingly, the silane coupling agent is not attached to the outer circumference of the battery cover 20, and the welding property between the battery cover 20 and the battery container main body 10 can be improved. As a result, sealing performance of the spot at which the battery cover 20 is welded to the battery container main body 10 may be improved.

Furthermore, according to the structure of the battery cover 20 of the first embodiment of the present invention, as the inner region portion 203 is installed via the step portion 202, adhesion strength can be improved. That is, for example, when external stress including many elements in the XY plane direction (horizontal direction) of the battery cover 20, in particular, elements in the X-axis direction is applied to the positive electrode terminal 21a, the external stress is transmitted to the step portion 202 from the inner region portion 203a of the battery cover 20 via the insulating resin 22. In this case, the step portion 202 may function as an elastic material having an elastic force with respect to the external stress, and as a result, the external stress can be absorbed and the adhesion strength can be improved.

### Second Embodiment

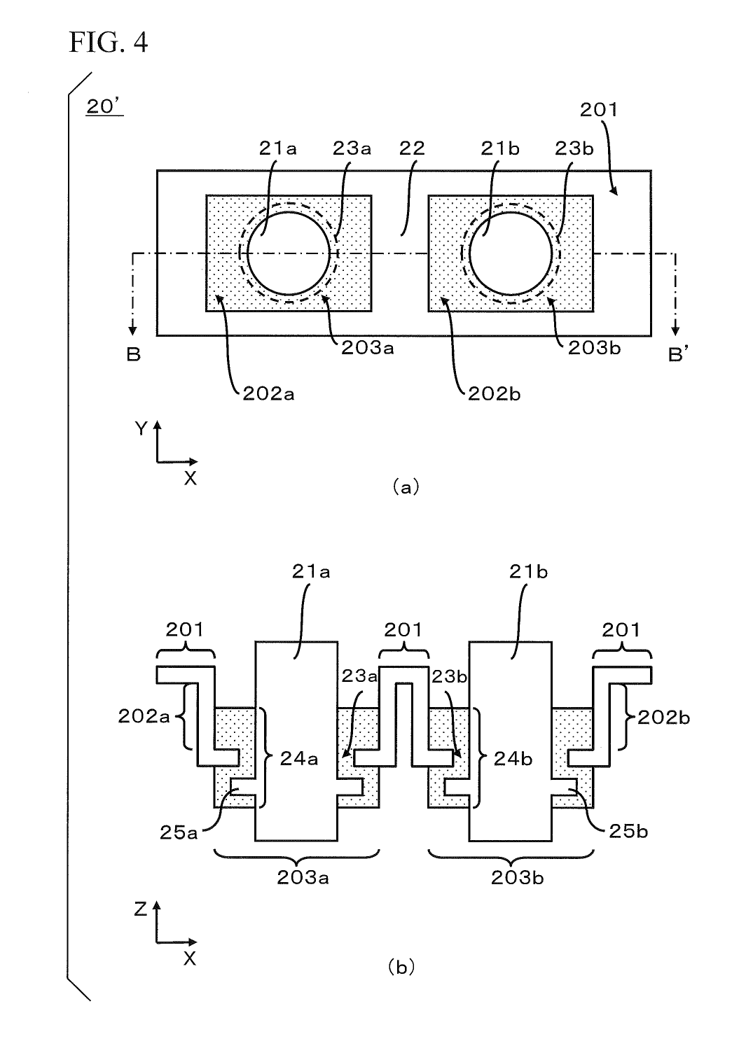

Next, a battery 1′ of a second embodiment of the present invention will be described in detail with reference to FIG. 4. In the battery 1 of the first embodiment, the two through-holes passing through the two electrode terminals (the positive electrode terminal 21a and the negative electrode terminal 21b), respectively, are arranged on the same plane on which the inner region portion 203 is continued via the step portion 202 of the battery cover, which is the “support member.” Meanwhile, the battery 1′ of the second embodiment is characterized in that inner region portions 203a and 203b are installed via step portions 202a and 202b of the battery cover, which is the “support member,” according to the number of electrode terminals, that is, each of the positive electrode terminal 21a and the negative electrode terminal 21b, and through-holes 23a and 23b are arranged in the inner region portions 203a and 203b, respectively. In addition, common components of the first embodiment will be appropriately omitted in the description below.

As shown in FIG. 4(a) and FIG. 4(b), a battery cover 20′ has regions of the outer region portion 201, the step portions 202a and 202b, and the inner region portions 203a and 203b on a surface of the battery cover 20′. The inner region portion 203a has the through-hole 23a through which the positive electrode terminal 21a is exposed, and the inner region portion 203b has the through-hole 23b through which the negative electrode terminal 21b is exposed. On surfaces of the inner region portions 203a and 203b that cover the opening of the battery container main body 10, the surfaces of the inner region portions 203a and 203b are arranged in the −Z direction (the bottom surface side of the battery container main body 101) via the step portions 202a and 202b, rather than a surface of the outer region portion 201. As shown in FIG. 4(b), a cross-sectional shape of the battery cover 20′ may be configured such that a cross-section of the outer region portion 201 and the inner region portion 203a and a cross-section of the step portion 202a have a predetermined angle (for example, 90 degrees), and further, a cross-section of the outer region portion 201 and the inner region portion 203b and a cross-section of the step portion 202b have a predetermined angle (for example, 90 degrees).

In the battery cover 20′ including the regions, the positive electrode terminal 21a that passes through the through-hole 23a arranged in the inner region portion 203a and is exposed. And, the positive electrode terminal 21a is integrally adhered to the battery cover 20′ by the insulating resin 22. In addition, the negative electrode terminal 21b that passes through the through-hole 23b arranged in the inner region portion 203b and is exposed. And, the negative electrode terminal 21b is integrally adhered to the battery cover 20′ by the insulating resin 22. At this time, the insulating resin 22 is formed to closely contact the adhesion place 24a of the positive electrode terminal 21a and at least a portion of the inner region portion 203a and the step portion 202a, and formed to closely contact the adhesion place 24b of the negative electrode terminal 21b and at least a portion of the inner region portion 203b and the step portion 202b.

According to the battery 1′ of the second embodiment of the present invention as configured above, in addition to effects of the battery 1 of the first embodiment, the following further remarkable effects can be provided.

According to the battery 1′ of the second embodiment of the present invention, the inner region portions 203a and 203b are installed at the positive electrode terminal 21a and the negative electrode terminal 21b connected to the step portions 202a and 202b, respectively. In other words, the positive electrode terminal 21a can be positioned at a concave-shaped center formed as the step portion 202a and the inner region portion 203a. In addition, the insulating resin 22 is filled between the positive electrode terminal 21a and the step portion 202a over the entire circumference of the positive electrode terminal 21a. Further, similar to the positive electrode terminal 21a, the insulating resin 22 is also filled between the negative electrode terminal 21b and the step portion 202b over the entire circumference of the negative electrode terminal 21b. According to the above-mentioned structure, adhesion strength (bonding strength) between each of the positive electrode terminal 21a and the negative electrode terminal 21b and the battery cover 20′ can be further improved. That is, for example, even when external stress including an element in the horizontal direction of the battery cover 20′ is applied to the positive electrode terminal 21a from an arbitrary direction, since the step portion 202a is formed around the positive electrode terminal 21a, the external stress is transmitted to the step portion 202a from the inner region portion 203a of the battery cover 20′ via the insulating resin 22. As the step portion 202a functions as an elastic material, the external stress can be absorbed, and as a result, adhesion strength can be improved.

In addition, since the battery cover 20′ of the second embodiment of the present invention is configured such that only near regions, in which the through-holes 23a and 23b are arranged, are provided on the battery cover 20′ via the step portions 202a and 202b as the inner region portions 203a and 203b, it is useful in that a space in which a safety valve is installed can be secured in the outer region portion 201 on the battery cover 20′.

Further, according to the structure of the battery cover 20′ of the second embodiment of the present invention, when the safety valve is installed at the outer region portion 201 on the battery cover 20′, welding property of a welded portion of the safety valve can be improved. Since the battery cover 20′ is a flat plate having concave and convex portions, only the step portions 202a and 202b and the inner region portions 203a and 203b can be immersed in the silane coupling agent. Accordingly, since the silane coupling agent is not attached to the safety valve arranged at the outer region portion 201 of the battery cover 20′, the welding property of the welded portion of the safety valve can be improved, and as a result, sealing performance of the battery container can be enhanced.

<Variant>

While the exemplary embodiments of the electrical appliance of the present invention have been described, the present invention is not limited to the above-mentioned embodiments, and various modifications, additions and omission may be made by those skilled in the art without departing from the spirit and scope of the following claims.

For example, in the respective embodiments, while the battery, in particular, a lithium secondary battery, which is an electrical appliance, has been exemplarily described, the present invention is not limited thereto but may be applied to an electrical appliance having a structure in which the support member and the electrode terminal are sealed by the insulating resin.

In addition, in the respective embodiments, while a square battery container has been exemplarily described as a battery container, the present invention is not limited thereto but may be, for example, a cylindrical battery container under the condition that the battery has a structure in which the battery cover and the electrode terminal, which are “support members,” are sealed by the insulating resin. Then, in the respective embodiments, while the two electrode terminals, the positive electrode terminal 21a and the negative electrode terminal 21b, are exemplarily described, the present invention is not limited thereto, and at least one electrode terminal may be configured according to kinds, shapes or uses of the electrical appliances such that the insulating resin is formed to closely contact the adhesion place and the inner region portion and the step portion of the “support member.”

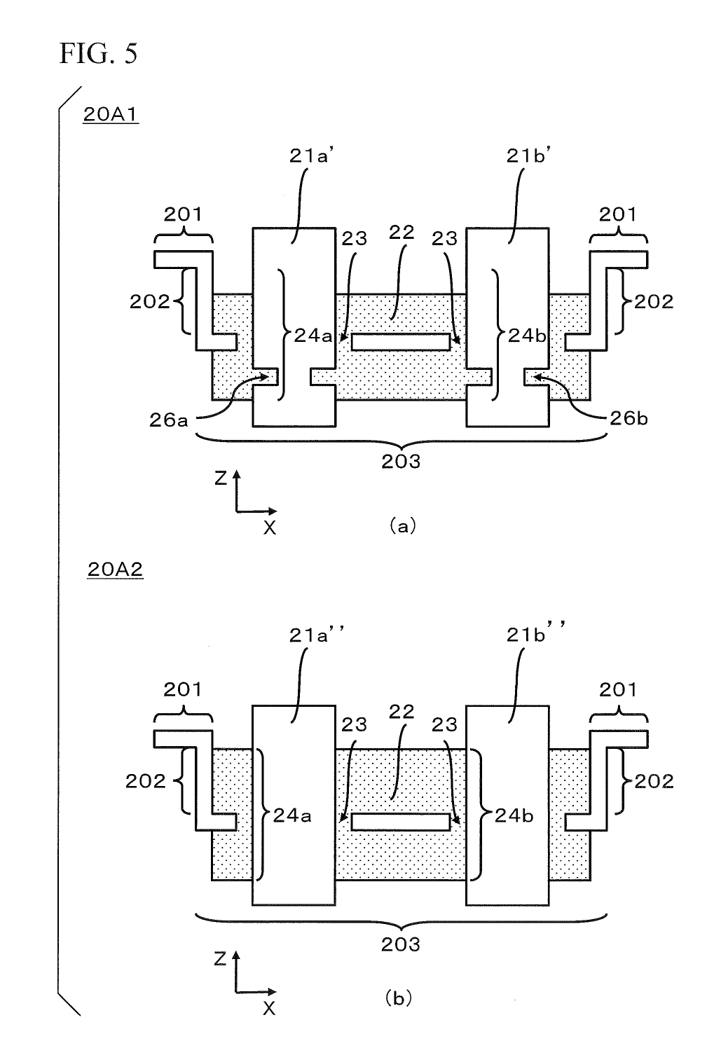

Further, in the respective embodiments, while the case in which the convex portions 25a and 25b are formed at portions of the adhesion places 24a and 24b of the electrode terminals (the positive electrode terminal 21a and the negative electrode terminal 21b) has been described, the present invention is not limited thereto. For example, a battery cover 20A1 shown in FIG. 5(a) may be formed as a variant 1 of the first embodiment. In the battery cover 20A1, concave portions 26a and 26b are formed at portions of the adhesion places 24a′ and 24b′ of the positive electrode terminal 21a and the negative electrode terminal 21b over the entire circumference in a direction perpendicular or substantially perpendicular to a direction passing through the through-holes 23. In this case, as the insulating resin 22 is formed to closely contact the concave portions of the positive electrode terminal 21a and the negative electrode terminal 21b, the close contact area between the battery cover 20A1 and the insulating resin 22 is increased. Accordingly, as a path between the positive electrode terminal 21a and the negative electrode terminal 21b and the insulating resin 22, through which external moisture, and so on, may pass, is increased, sealing performance can be improved. As a result, a moisture and so on, present outside the battery container can be suppressed from entering the inside, and simultaneously, an electrolyte and so on, present in the battery container can be suppressed from leaking to the outside.

Furthermore, in the respective embodiments, while the case in which the convex portions 25a and 25b are formed at portions of the adhesion places 24a and 24b of the electrode terminals (the positive electrode terminal 21a and the negative electrode terminal 21b) has been described, the present invention is not limited thereto. For example, a battery cover 20A2 shown in FIG. 5(b) may be formed as a variant 2 of the first embodiment. The convex portions 25a and 25b in adhesion places of a positive electrode terminal 21a″ and a negative electrode terminal 21b″ may be appropriately omitted in the battery cover 20A2. In this case, in a front surface side (an opposite side of the battery container main body side) of the battery cover 20A2, for example, the insulating resin 22, may be further filled (for example, filled to a height of a surface of the outer region portion 201) between the positive electrode terminal 21a and the step portion 202, and between the negative electrode terminal 21b and the step portion 202 in a direction in which the positive electrode terminal 21a″ and the negative electrode terminal 21b″ pass through the through-holes 23. As a result, the close contact area between the positive electrode terminal 21a″ and the insulating resin 22, and between the negative electrode terminal 21b″ and the insulating resin 22 can be increased, risk of moisture and so on, entering through the path between the positive electrode terminal 21a″ and the insulating resin 22, and the path between the negative electrode terminal 21b″ and the insulating resin 22 can be increased, and sealing performance can be improved.

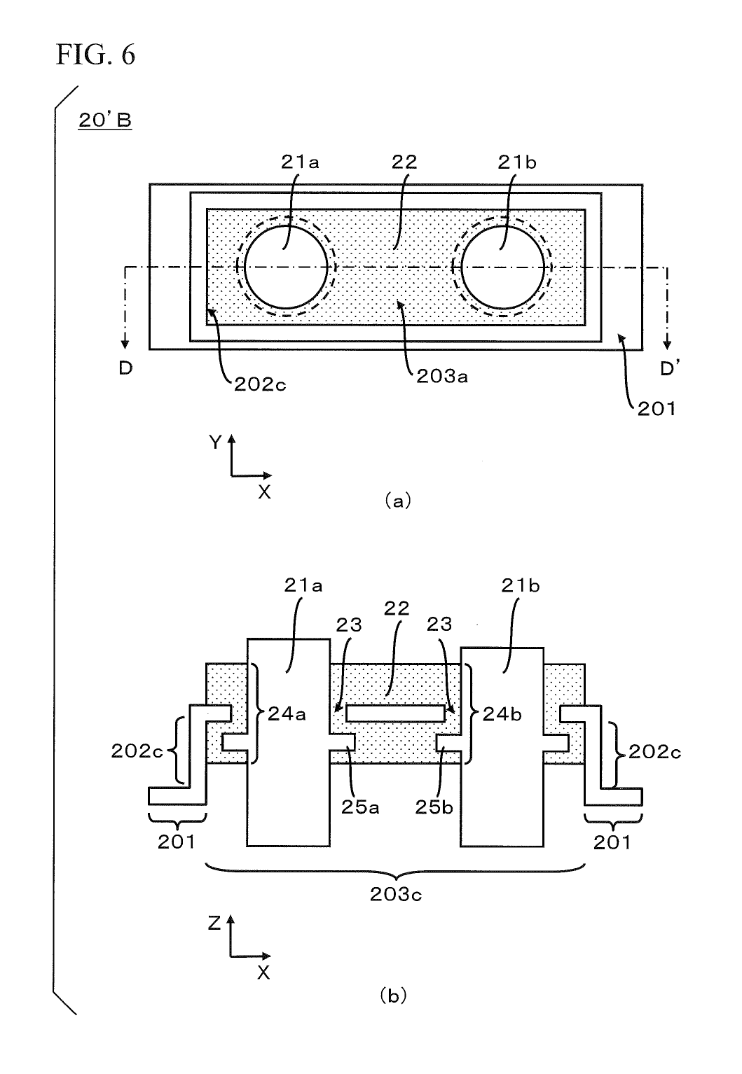

In addition, in the respective embodiments, while the case in which the inner region portions 203 (203a and 203b) of the battery cover 20 (20′) are arranged as the “support members” in the −Z direction (the bottom surface side of the battery container main body 10) in a surface covering the opening of the battery container main body 10, rather than a surface of the outer region portion 201, the present invention is not limited thereto. For example, in contrast to the battery 1 of the first embodiment, as shown in a battery cover 20′B of FIG. 6, an inner region portion 203c of the battery cover 20′B may be arranged in the +Z direction (an outer side of the battery container main body 10) in a surface covering the opening of the battery container main body 10 via the step portion 202c, rather than the surface of the outer region portion 201. In this case, in a place in which the electrode terminals (the positive electrode terminal 21a and the negative electrode terminal 21b) are arranged, since the battery cover 20 is not concaved at a bottom surface side of the battery container main body 10, spaces in which a positive electrode lead connecting the positive electrode terminal 21a to a positive electrode tab of the positive electrode plate and a negative electrode lead connecting the negative electrode terminal 21b to a negative electrode tab of the negative electrode plate are arranged, respectively, can be sufficiently secured.

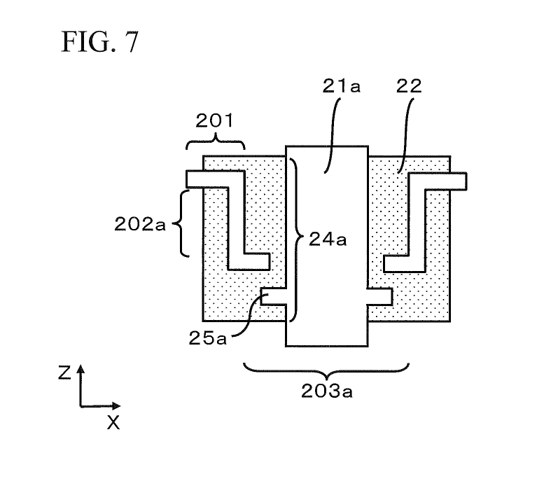

Further, as described above, the insulating resin 22 is not limited to the inner region portions 203 (203a and 203b) and the step portions 202 (202a and 202b) but may be formed to be arranged on the outer region portion 201. For example, as a variant of the positive electrode terminal 21a of the second embodiment, as shown in FIG. 7, the insulating resin 22 may be formed at a front surface side of the battery cover 20′ to fill between a surface of a portion of the outer region portion 201, a surface of the step portion 202a, a surface of the inner region portion 203c, and the adhesion place 24a of the positive electrode terminal 21a. Furthermore, the insulating resin 22 may be formed at a rear surface side of the battery cover 20 to fill between a surface of a portion of the outer region portion 201, a surface of the step portion 202a, a surface of the inner region portion 203a, and the adhesion place 24a of the positive electrode terminal 21a. As described above, as the insulating resin 22 is formed over a partial region of the outer region portion 201, sealing performance can be further increased, and adhesion strength (bonding strength) between the positive electrode terminal 21a and the battery cover 20′ can be further improved.

### DESCRIPTION OF REFERENCE NUMERALS

1, 1′ . . . Battery
10 . . . Battery container main body
20, 20′ . . . Battery cover
21a . . . Positive electrode terminal
21b . . . Negative electrode terminal
22 . . . Insulating resin
23, 23a, 23b . . . Through-hole
24a and 24b . . . Adhesion place
25a and 25b . . . Convex portion
201 . . . Outer region portion
202, 202a, 202b, 202c . . . Step portion
203, 203a, 203b, 203c . . . Inner region portion

What is claimed is:

1. An electrical appliance comprising:
a support member having a step portion and having an inner region portion in which a through-hole is formed;
an electrode terminal arranged to pass through the through-hole so as not to contact the support member, and of which at least one end is protruded from the support member; and
an insulating resin formed integrally and contacted to an adhesion place of the electrode terminal, the inner region portion and the step portion so as to seal the through-hole.

2. The electrical appliance according to claim 1, wherein the electrode terminal has a convex portion formed at a portion of the adhesion place over the entire circumference in a direction perpendicular or substantially perpendicular to a direction passing through the through-hole.

3. The electrical appliance according to claim 1, wherein the electrode terminal has a concave portion formed at a portion of the adhesion place over the entire circumference in a direction perpendicular or substantially perpendicular to a direction passing through the through-hole.

4. The electrical appliance according to claim 1, wherein the inner region portion is arranged at the battery container main body side through the step portion on a surface covering the opening of the battery container main body.

5. The electrical appliance according to claim 1, wherein the inner region portion is arranged at an opposite side of the battery container main body side through the step portion on a surface covering the opening of the battery container main body.

6. An electrical appliance comprising:
a container main body which stores an electrode plate; and
a support member, which covers an opening of the container main body, having a through-hole to expose an electrode terminal electrically connected to the electrode plate, from an inner region portion connected to a step portion on a surface of the support member,
wherein the support member is integrated with the electrode terminal passing through the through-hole, for an insulating resin to adhere an adhesion place of the electrode terminal, the inner region portion, and the step portion.

7. The electrical appliance according to claim 6, wherein the support member has the inner region portion in which the through-hole is arranged according to the number of electrode terminals.

8. The electrical appliance according to claim 6, wherein the electrode terminal has a convex portion formed at a portion of the adhesion place over the entire circumference in a direction perpendicular or substantially perpendicular to a direction passing through the through-hole.

9. The electrical appliance according to claim 6, wherein the electrode terminal has a concave portion formed at a portion of the adhesion place over the entire circumference in a direction perpendicular or substantially perpendicular to a direction passing through the through-hole.

10. The electrical appliance according to claim 6, wherein the inner region portion is arranged at the battery container main body side through the step portion on a surface covering the opening of the battery container main body.

11. The electrical appliance according to claim 6, wherein the inner region portion is arranged at an opposite side of the battery container main body side through the step portion on a surface covering the opening of the battery container main body.
